(19) United States
(12) Patent Application Publication
(10) Pub. No.: US 2013/0179001 A1
(43) Pub. Date: Jul. 11, 2013

(54) CONTROL UNITS ON BOARD THE MOTOR VEHICLE

(71) Applicant: Stefan NORDBRUCH, Kornwestheim (DE)

(72) Inventor: Stefan NORDBRUCH, Kornwestheim (DE)

(73) Assignee: Robert Bosch GmbH, Stuttgart (DE)

(21) Appl. No.: 13/737,027

(22) Filed: Jan. 9, 2013

(30) Foreign Application Priority Data
Jan. 9, 2012 (DE) 10 2012 200 181.6

(51) Int. Cl. G06F 17/00

(52) U.S. Cl. CPC G06F 17/00
USPC 701/1

(57) ABSTRACT

A system for controlling a motor vehicle includes a first electronic control unit on board the motor vehicle, which is designed to obtain a predetermined piece of information from a second electronic control unit, and at least one second electronic control unit on board the motor vehicle, which is designed to provide the predetermined piece of information. In addition, the system includes a first processing unit for determining which of the second electronic control units provides the information and a second processing unit for selecting which of the determined second control units provides the highest quality information in order to allow the first control unit to obtain the information from the selected second control unit.

### CROSS REFERENCE

The present application claims the benefit under 35 U.S.C. §119 of German Patent Application No. DE 102012200181.6 filed on Jan. 9, 2012, which is expressly incorporated herein by reference in its entirety.

### BACKGROUND INFORMATION

Multiple electronic control units, which communicate with one another, are usually installed on board a motor vehicle to allow for repeated evaluation of the provided information using the different control units. For example, a speed signal which is provided by an electronic ABS system may also be evaluated by a navigation system or an active restraint system for passengers of the motor vehicle.

If one of the electronic control units fails, another control unit may be limited in its function since it is no longer able to receive the information provided by the first control unit.

Consequently, the other control unit may be switched off or put into a safe operating mode in which it only partially fulfills its intended function. This is usually associated with a safety or comfort loss which may limit the usability of the motor vehicle.

### SUMMARY

It is an object of the present invention to provide a system for controlling the motor vehicle which allows for an improved usability of the motor vehicle under the described circumstances. Another object of the present invention is based on the provision of an electronic control unit on board the motor vehicle which provides the function of another failed control unit on board the motor vehicle with the smallest possible limitations.

Yet another object of the present invention is based on the provision of a method for operating the control unit on board the motor vehicle.

An example system in accordance with the present invention for controlling a motor vehicle includes a first electronic control unit on board the motor vehicle, the control unit being designed to obtain a predetermined piece of information from a second electronic control unit on board the motor vehicle, and at least one second electronic control unit on board the motor vehicle, the second control unit being designed to provide the predetermined piece of information. In addition, the example system includes a first processing unit for determining which of the second electronic control units provide the information, and a second processing unit for selecting which of the determined second control units provide the highest quality information in order to allow the first control unit to obtain the information from the selected second control unit.

In the example system in accordance with the present invention, the first electronic control unit is capable of always obtaining the respective relevant information from the one second control unit which is able to provide the highest quality information. If, for example, the second control unit having the highest quality information fails, the first control unit may obtain the respective relevant information from the control unit which then has the highest information quality. In this way, failures, switch offs, or partial switch offs of individual electronic control units on board the motor vehicle may be handled in such a way that other electronic control units are impaired thereby in their function to the smallest possible extent.

In one preferred specific embodiment, an information device is provided for providing an indication regarding the at least one second control unit which provides the predetermined piece of information. In this way, the information qualities may be kept ready centrally in the information device. Handling expenditures may thus be reduced.

In one first variant, the information device is situated outside of the motor vehicle and a wireless communication device for connecting the control units to the information device is provided on board the motor vehicle. The information concerning which of the second control units provides which information at which quality may therefore be kept ready outside of the motor vehicle where an improved data management may be facilitated, e.g., based on statistical information regarding a plurality of comparable motor vehicles.

In another variant, the information device is situated on board the motor vehicle. Data management of the information stored in the information device may thus also be facilitated. Moreover, access to this information may be independent of an availability of a wireless communication link.

A wireless communication device may still be provided for receiving updated indications regarding the second control units on board the motor vehicle. In this way, the indications may be quickly locally accessible and, with the aid of the wireless communication device, still be kept up-to-date with regard to an information source outside of the motor vehicle.

In another specific embodiment, an interface for an input device for inputting updated indications may be provided on board the motor vehicle. In this way, a driver of the motor vehicle or service personnel in a repair shop may, for example, quickly adapt the indications as a function of an operating mode or a service measure.

Here, the updated indications may each be directed to the information device. The distribution of updated indications to the individual control units may be facilitated thereby.

The information device may be designed to provide the indication as a response to a corresponding query of the first control unit. The first control unit may pose the query at a suitable point in time, each time the motor vehicle is started or immediately before the information is obtained from the second control unit, for example, in order to always have the indication instantaneously available regarding the second control unit to be used.

The information device may also be designed to provide the indication as a response to an updated indication regarding the second control unit. In this way, it is possible to rapidly distribute, even to a large plurality of control units, a change as to which second control unit may provide the highest information quality for a predetermined piece of information.

An example electronic control unit according to the present invention on board a motor vehicle, the control unit being designed to obtain a predetermined piece of information from another electronic control unit on board the motor vehicle, is furthermore designed to determine which other at least one control unit on board the motor vehicle provides the information, to select which of the determined control units provides the highest quality information, and to obtain the information from the selected control unit.

An existing electronic control unit for a motor vehicle may be refined at a reasonable cost to obtain the control unit according to the present invention in order to provide an improved functionality even in the case of failure of other control units, as already described above.

An example method in accordance with the present invention for operating a first electronic control unit on board a motor vehicle includes the following steps carried out by the first control unit: Determining which at least one second electronic control unit on board the motor vehicle provides a predetermined piece of information; selecting which of the determined control units provides the highest quality information; and obtaining the information from the selected control unit.

The example method may advantageously be carried out on the described electronic control unit. The configuration of the above-described system may thus be easily implementable.

An example computer program product includes program code to carry out the described example method, when the computer program product runs on a processing unit or is stored on a computer-readable data carrier.

### BRIEF DESCRIPTION OF THE DRAWINGS

Example embodiments of the present invention are described below in greater detail with reference to the figures.

FIG. 1 shows a system for controlling a motor vehicle.

FIG. 2 shows a variant of the system of FIG. 1.

FIG. 3 shows a diagram for obtaining a piece of information between multiple control units in the systems of FIG. 1 or 2.

FIG. 4 shows a modified diagram corresponding to the one in FIG. 3.

FIG. 5 shows a flow chart of a method for operating an electronic control unit on board a motor vehicle.

### DETAILED DESCRIPTION OF EXAMPLE EMBODIMENTS

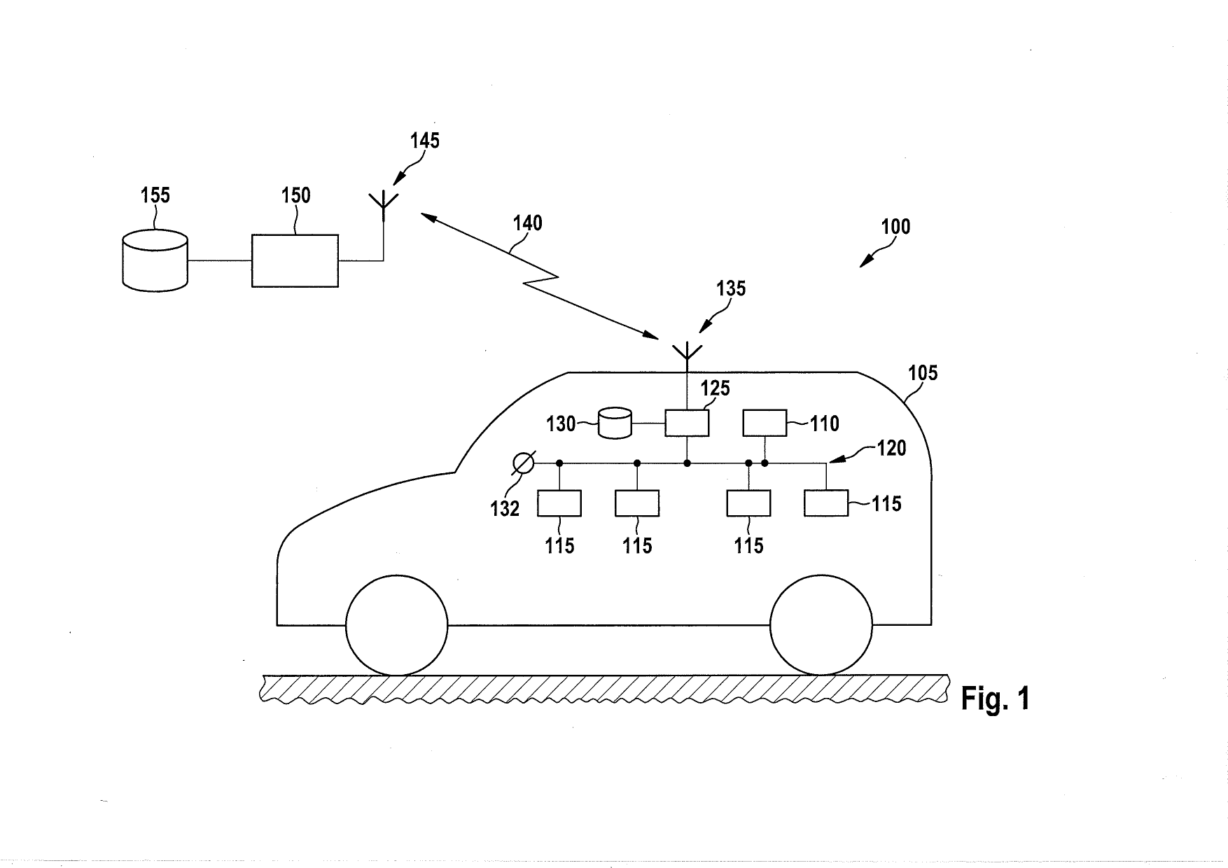

FIG. 1 shows a system 100 for controlling motor vehicle 105. A first electronic control unit 110 and multiple second electronic control units 115 are situated on board motor vehicle 105. Control units 110, 115 are interconnected with the aid of a network 120. Network 120 may, in particular, include a bus, a CANBUS, for example, or one or multiple point-to-point connections.

An information device 125 having a data memory 130 is connected to network 120. Data memory 130 may also be integrated into information device 125. An interface 132 which is connected to network 120 is optionally provided to allow a user to input information into one of the other devices which are connected to network 120, e.g., one of control units 110, 115.

Information device 125 is optionally connected to a wireless communication device 135. Communication device 135 is designed to establish a communication link 140 which includes a wireless section, e.g., a WLAN, a Bluetooth, an LTE, a car-to-car (C2C), or a car-to-infrastructure (C2I) connection. Communication link 140 may also be established with the aid of a mobile phone which is connected wirelessly or in a wire-bound manner to information device 125 or network 120. Communication link 140 leads to a wireless communication device 145 of a central point 150 having a data memory 155.

System 100 includes at least first control unit 110, a second control unit 115, network 120, and information device 125. All or some of the other shown and described elements may be included in different specific embodiments.

Each control unit 110, 115 provides a function on board motor vehicle 105, e.g., an administrative function such as an engine control unit, a safety function such as a distance radar, or a comfort function such as a parking assistant. In this case, every control unit 110, 115 may be connected to a number of sensors which are not illustrated in FIG. 1. On the basis of sensor data, processing units 110, 115 determine the intermediate results which they may provide to other processing units 110, 115 via network 120. On the basis of the provided information, the other processing units 110, 115 may carry out other determinations whose results they may share with the other control units 110, 115. Moreover, each of control units 110, 115 may be connected to one or multiple actuators to influence an operating mode of motor vehicle 105.

Some pieces of information are provided by multiple control units 110, 115 in parallel. It is assumed in the following that each of second control units 115 provides one piece of information which is supposed to be further processed by first control unit 110. Here, the pieces of information of second control unit 115 are concerning the same subject matter, e.g., a vehicle speed or an outdoor temperature. These pieces of information are usually provided by individual second control units 115 at different quality levels.

The quality of the provided information, i.e., the particular information quality, may be determined based on a plurality of different criteria. The quality may, for example, include the accuracy of the provided information, a frequency of an update, an availability, the length of a communication path, or a capacity utilization of the providing second control unit. The frequency and the accuracy are usually the preferably used criteria to specify the information quality.

To be sure that first control unit 110 always obtains the respective relevant information from the one control unit 115 which provides the highest information quality, information device 125, which provides information to second control units 115, keeps ready indications in its data memory 130. Before first control unit 110 obtains its information from one of second control units 115, it is notified with the aid of information device 125 from which of second control units 115 the highest quality information is to be obtained.

First control unit 110 may actively query the corresponding indication from information device 125. Information device 125 may also forward the indication to first control unit 110 at its own instigation, for example, when the availability of one of second control units 115 changes.

The indications of information device 125 may be updated by central point 150 via communication link 140. The update may be triggered, if necessary, either by information device 125 or by central point 150. A timed update is also possible.

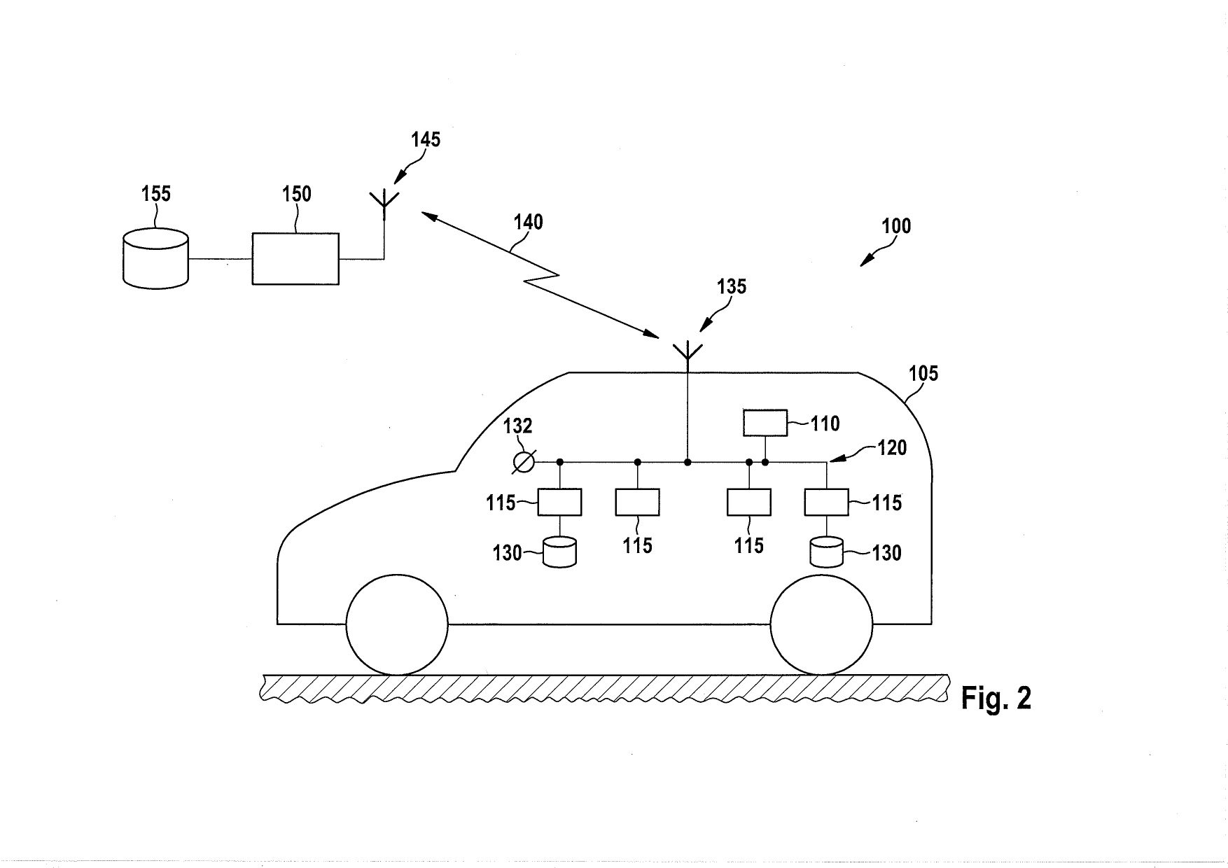

FIG. 2 shows a variant of system 100 from FIG. 1. In the shown variant, information device 125 is missing on board motor vehicle 105; instead, data memories 130, each of which includes at least some of the required indications, are situated on multiple or all control units 110, 115. The indications distributed via data memories 130 are ideally consistent and furthermore cover all processing units 110, 115 on board motor vehicle 105.

Communication link 140 is connected to network 120 so that at least one of control units 110, 115 is able to directly communicate with central point 150. In this way, an update of the indications may take place in data memories 130, as described above.

In another specific embodiment, all data memories 130 on board motor vehicle 105 are dispensed with, all indications regarding second control units 115 and their particular information qualities being provided by central point 150 via communication link 140.

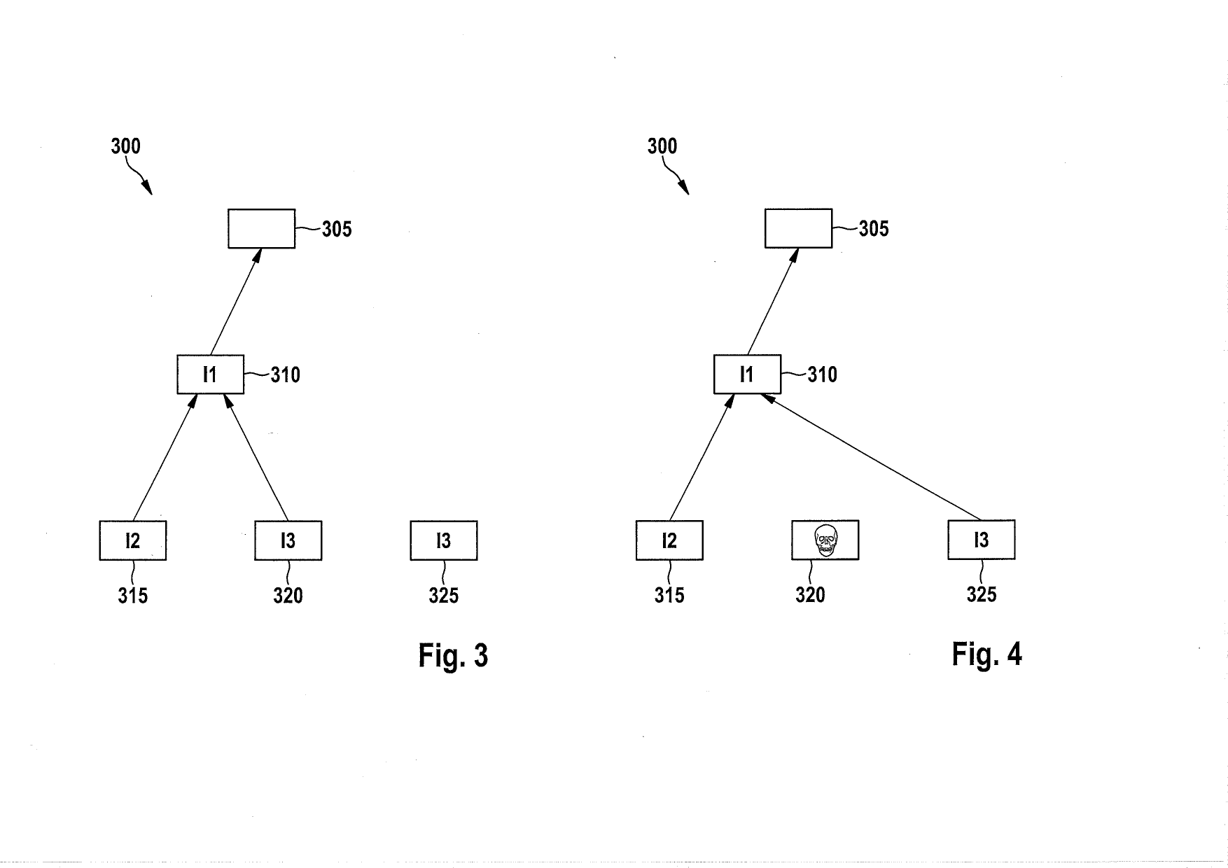

FIG. 3 shows an exemplary diagram 300 for obtaining a piece of information between multiple control units of systems 100 of FIGS. 1 and 2. A first control unit 305 which corresponds to first control unit 110 from FIGS. 1 and 2 obtains a predetermined piece of information I1 from a second control unit 310. The latter provides piece of information I1 on the basis of pieces of information I2 and I3 which are provided by a third control unit 315 and a fourth control unit 320. A fifth control unit 325 also provides piece of information I3. Control units 310 through 325 are each second control units 115 in the sense of the illustrations in FIGS. 1 and 2.

The information quality of piece of information I3 provided by fourth control unit 320 is higher than identical piece of information I3 provided by fifth control unit 325. For its provision with respective relevant pieces of information I1 through I3, first control unit 305 thus uses control units 310, 315, and 320. In this case, fifth control unit 325 does not contribute any information to the operation of first control unit 305.

FIG. 4 shows diagram 300 from FIG. 3 after fourth control unit 320 was switched off completely or partially so that the associated information quality is reduced. The switch off may be based on an error in operation, a sensor error, or a system error of fourth control unit 320. Since fourth control unit 320 may only provide piece of information I3 having bad information quality or not at all, second control unit 310 obtains piece of information I3 no longer from fourth control unit 320, but from fifth control unit 325. Consequently, for its provision with respective relevant pieces of information I1 through I3, first control unit 305 uses control units 310, 315, and 325, while fourth control unit 320 does not contribute to the operation of first control unit 305.

In the way shown in FIGS. 3 and 4, simple or complex, complete or partial limitations of the functionality of one or more control units may be balanced in such a way that the remaining control units may still continue to work with information of the highest possible quality.

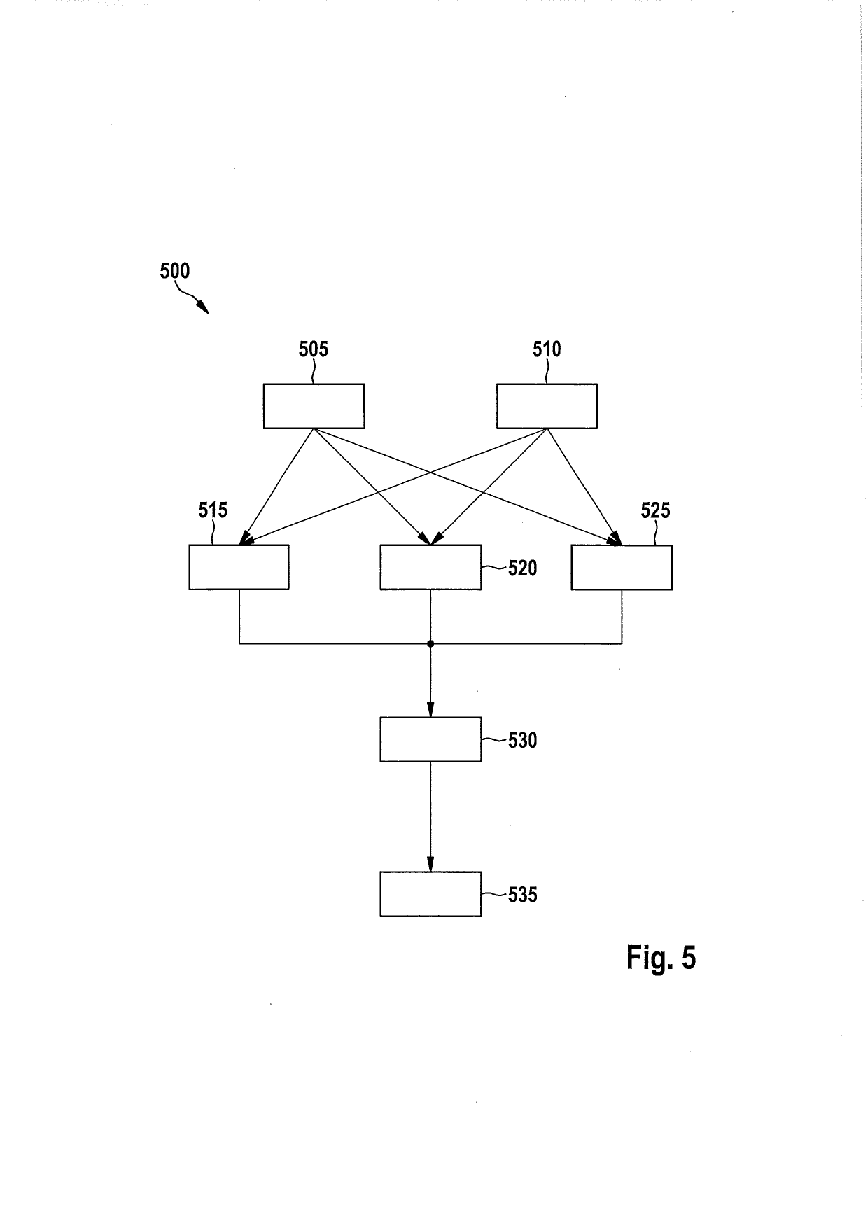

FIG. 5 shows a flow chart of a method 500 for operating an electronic control unit on board a motor vehicle. Method 500 is, in particular, suitable to be carried out on control units 110, 115 of motor vehicle 105 of system 100 from FIGS. 1 and 2.

Method 500 starts in a step 505 in which first control unit 110 transmits a query as to which second control unit 115 provides a predetermined piece of information and at which information quality.

Depending on the configuration of system 100, method 500 proceeds with one of steps 515, 520, or 525.

In step 515, it is assumed that the query of first control unit 110 was directed to information device 125 or central point 150. Accordingly, information device 125 or central point 150 responds with an indication regarding all second control units 115 which provide the predetermined piece of information, preferably also indicating the respective information quality.

In step 520, it is assumed that the query of first control unit 110 in step 505 was directed to all second control units 115. Accordingly, each of second control units 115 responds with an indication regarding itself if it provides the corresponding information. It preferably also adds a specification of the achievable information quality to this indication.

In step 525, it is assumed that only some of second control units 115 are connected to data memories 130 as in the specific embodiment shown in FIG. 2. The query of first control unit 110 in step 505 is directed to these second control units 115. Second control units 115, in whose data memories 130 indications regarding second control unit 115 which provides the information are stored, respond with the corresponding specifications, preferably adding their respective achievable information quality.

Instead of via step 505, method 500 may also be initiated via a step 510 in which an indication regarding one of second control units 115 is updated at the particular relevant point. In one of steps 515, 520, or 525 following step 510, a corresponding provision of indications takes place regarding second control units 115 or the information qualities achievable thereby.

In a subsequent step 530, the one of second control units 115 is selected which is able to provide the highest information quality. In the case of equally high information qualities, a decision may be brought about on an arbitrary basis, e.g., by chance. Step 530 is preferably carried out by first control unit 110, but it may also be carried out by information device 125 or central point 150, if necessary.

In a step 535, first control unit 110 subsequently obtains the information from second control unit 115 selected in step 530.

What is claimed is:

1. A system for controlling a motor vehicle, comprising:
a first electronic control unit on board the motor vehicle which is configured to obtain a predetermined piece of information from a second electronic control unit;
at least one second electronic control unit on board the motor vehicle which is configured to provide the predetermined piece of information;
a first processing unit configured to determine which of the second electronic control units provide the information; and
a second processing unit configured to select which of the determined second control units provides the highest quality information to allow the first control unit to obtain the information from the selected second control unit.

2. The system as recited in claim 1, furthermore comprising:
an information device configured to provide an indication regarding the at least one second control unit which provides the predetermined piece of information.

3. The system as recited in claim 2, wherein the information device is situated outside of the motor vehicle and a wireless communication device is provided on board the motor vehicle to connect the first and second electronic control units to the information device.

4. The system as recited in claim 2, wherein the information device is situated on board the motor vehicle.

5. The system as recited in claim 4, wherein a wireless communication device for receiving updated indications is further provided on board the motor vehicle.

6. The system as recited in claim 5, further comprising:
an interface for an input device for inputting updated indications, the interface being situated on board the motor vehicle.

7. The system as recited in claim 6, wherein the updated indications are each directed only to the information device.

8. The system as recited in claim 7, wherein the information device is configured to provide the indication as a response to a corresponding query of the first control unit.

9. The system as recited in claim 8, wherein the information device is configured to provide the indication as a response to an updated indication regarding the second control unit.

10. An electronic control unit on board a motor vehicle, the control unit being configured to obtain a predetermined piece of information from another electronic control unit on board the motor vehicle, wherein the control unit is configured to determine which other at least one control unit on board the motor vehicle provides the information, to select which of the determined control units provides the highest quality information, and to obtain the information from the selected control unit.

11. A method for operating a first electronic control unit on board a motor vehicle, comprising:
determining, by the first control unit, which at least one second control unit on board the motor vehicle provides a predetermined piece of information;
selecting, by the first electronic control unit, which of the determined second control units provides the highest quality information; and
obtaining the information from the selected control unit.

12. A computer readable data carrier storing program code to operate a first electronic control unit onboard a motor vehicle, the program code, when executed by a processing unit, causing the processing unit to perform the steps of:
determining, by the first control unit, which at least one second control unit on board the motor vehicle provides a predetermined piece of information;
selecting, by the first electronic control unit, which of the determined second control units provides the highest quality information; and
obtaining the information from the selected control unit.
